(19) United States
(12) Patent Application Publication
(10) Pub. No.: US 2005/0079599 A1
(43) Pub. Date: Apr. 14, 2005

(54) Method for producing sheet-like structures for gas diffusion electrodes

(76) Inventors: Andreas Bulan, Langenfeld (DE); Fritz Gestermann, Leverkusen (DE); Gunter Poppelreuter, Leichlingen (DE)

Correspondence Address: CONNOLLY BOVE LODGE & HUTZ LLP, SUITE 800, 1990 M STREET NW, WASHINGTON, DC, 20036-3425, US

(21) Appl. No.: 10/496,510

(22) PCT Filed: Nov. 15, 2002
(86) PCT No.: PCT/EP02/12811

(30) Foreign Application Priority Data
Nov. 23, 2001 (DE) 101 57 521.1

(51) Int. Cl. C12M 1/34

(52) U.S. Cl. 435/287.2; 205/777.5

(57) ABSTRACT

The invention relates to a method for producing textile constructions for gas diffusion electrodes, particularly for use in electrolysis cells, according to which the textile construction is produced by rolling a dry power mixture containing at least one catalyst or one catalyst mixture and one binder. In a first preferred embodiment of the method, a liquid organic compound, particularly an alcohol, a ketone, an ester or a mixture of liquid organic compounds of this type is applied to the roll surfaces of the roll pair before bringing it into contact with the powder mixture, whereupon the roll surfaces are dried. In a second preferred embodiment, optionally in addition to the treatment of the roll surfaces with the liquid organic compound, ground powder made of polytetrafluoroethylene is rolled into a textile construction before rolling the dry power mixture.

The invention relates to a method for producing sheet-like structures for gas diffusion electrodes, in particular for use in electrolysis cells, by rolling a powder mixture containing at least one catalyst or a catalyst mixture and a binder.

DE-A 37 10 168 and EP-A 297 377 disclose methods for producing a plastics-bound gas diffusion electrode comprising metallic electrocatalysts, in which dry powder mixtures containing at least one binder, e.g. polytetrafluoroethylene (PTFE), and a catalyst metal and/or a nonmetallic compound of a metal forming a catalyst, e.g. silver oxide or copper oxide, are rolled to give sheet-like structures and then applied to a mechanical support, for example a metal net, metal nonwoven or woven metal fabric. The application to the mechanical support is effected in particular by rolling in or pressing.

A disadvantage of the known methods is that the sheet-like structure remains adhering to the roll surface at the beginning of and/or during the rolling process instead of being released from said surface. It is therefore not possible to produce sheet-like structures which have the area necessary for technical handling, for example a length of from 2 to 3 meters and a width of from 30 to 40 cm in the case of an electrochemical preparation of chlorine from aqueous solutions of alkali metal chloride or aqueous solutions of hydrogen chloride. With regard to its density and thickness, the sheet-like structure must have sufficient homogeneity over its entire area. Moreover, owing to the adhering material, the rolling process has to be interrupted in order to clean the rolls. If this is effected by means of mechanical scraping aids, such as, for example, a knife, the sheet-like structure is very easily damaged and is no longer available for further processing. The valuable material containing noble metal has to be discarded or fed to a suitable recycling process. A further disadvantage of the known method is that two or more sheet-like structures which have the same composition and were produced under the same rolling conditions no longer, however, have the same properties, in particular the same thickness and density, and hence the same electrochemical activity if in the meantime one or more sheet-like structures were produced with a different composition and/or with different rolling parameters.

It is an object of the present invention to provide a method for producing sheet-like structures for gas diffusion electrodes by rolling a dry powder mixture, in which the sheet-like structure does not remain adhering to the roll surfaces.

The object is achieved, according to the invention, by the features of claim 1 or 2. In a first preferred embodiment of the method according to the invention for producing sheet-like structures for gas diffusion electrodes, in particular for use in electrolysis cells, the sheet-like structure is produced by rolling a powder mixture containing at least one binder and a catalyst or a catalyst mixture, according to the invention a liquid organic compound, in particular an alcohol of the general formula 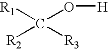
in which R₁, R₂ and R₃ are identical or different and are hydrogen or are aliphatic or cycloaliphatic alkyl radicals, R₁, R₂ and R₃ together comprising not more than 8 C atoms, or are aryl radicals having 6 C atoms, not more than one of the radicals R₁, R₂ or R₃ being an aryl radical in which optionally one or more hydrogen atoms are replaced by an alkyl radical having not more than 8 C atoms, or a mixture of such alcohols and/or a ketone of the general formula 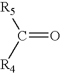
in which R₄ and R₅ are identical or different and are aliphatic or cycloaliphatic alkyl radicals, R₄ and R₅ together comprising not more than 8 C atoms, or are aryl radicals having 6 C atoms, not more than one of the radicals R₄ or R₅ being an aryl radical in which optionally one or more hydrogen atoms are replaced by an alkyl radical having not more than 8 C atoms, or a mixture of such ketones and/or an ester of the general formula 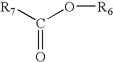
in which R₆ and R₇ are identical or different and are aliphatic or cycloaliphatic alkyl radicals, R₆ and R₇ together comprising not more than 8 C atoms, or R₇ is an aryl radical having 6 C atoms in which optionally one or more hydrogen atoms are replaced by an alkyl radical having not more than 8 C atoms, or a mixture of such esters is applied to the roll surfaces of the pair of rolls, so that the total surface area is covered, before being brought into contact with the powder mixture, and the rolls are then dried.

Preferred organic liquid compounds for the treatment of the rolls are conventional organic solvents, in particular ethanol, isobutyl ketone or acetone.

The liquid organic compound can be sprayed onto the roll surfaces, for example, before the rolling process or can be applied to the roll surfaces with the aid of paint brushes, brushes, cloths or the like. The subsequent drying is effected by evaporation at room temperature or is accelerated with the aid of a hot air stream or the like. The roll surfaces can also be rubbed for drying. It may also be necessary to carry out the treatment of the roll surfaces continuously or at regular or irregular intervals during the rolling process, in addition to or instead of the application of the liquid organic compound before the rolling process. What is decisive is that the roll surfaces are treated by the method according to the invention before the surfaces are brought into contact with the powder to be rolled. In order to avoid having to interrupt the rolling process, paint brushes, brushes, cloths or the like and an apparatus for drying in a suitable manner are mounted on the rolling apparatus.

In a second preferred embodiment of the method according to the invention, milled powder comprising polytetrafluoroethylene is optionally rolled to give a sheet-like structure, in addition to the treatment of the roll surfaces with the liquid organic compound, before the rolling of the dry powder mixture. A combination of the two preferred embodiments of the method according to the invention is particularly preferred.

If the two steps of the method are combined, preferably the milled powder comprising polytetrafluoroethylene is first rolled to give a sheet-like structure, the liquid organic compound is then applied to the roll surfaces, and the roll surfaces are then dried before the dry powder mixture is rolled to give a sheet-like structure for gas diffusion electrodes.

The preferably dry powder mixture for the sheet-like structure material may consist of a binder, e.g. a polymer, such as polytetrafluoroethylene (PTFE), and a catalyst or a catalyst mixture. It is also possible for one of the components of the powder mixture to be carbon or a carbon-containing compound. The powder mixture may also contain additives, such as, for example, ammonium bicarbonate, which acts as a pore former. The catalyst or the catalyst mixture may consist, for example, of the nonmetallic compound of a metal forming the catalyst or of mixtures of metal and of the nonmetallic compounds of a metal-forming catalyst. Furthermore, mixtures of different metals or metal compounds, preferably noble metals, may be used. The moisture content of the powder mixture is not more than 0.5% by weight of H₂O, preferably not more than 0.3% by weight of H₂O. If said sheet-like structure is a sheet-like structure for use as a gas diffusion electrode in the electrolysis of an aqueous solution of alkali metal chloride, in particular sodium chloride, the compound containing the catalyst metal is in particular silver(I) oxide.

Surprisingly, owing to the method according to the invention, the resulting sheet-like structure for gas diffusion electrodes no longer remains adhering to the roll surfaces during the rolling of the powder mixture. The method according to the invention therefore permits the production of homogeneous sheet-like structures having, for example, a length of 2 m and a width of 0.4 m. The homogeneity of the sheet-like structure relates in particular to the thickness and density. It influences the electrochemical activity of the gas diffusion electrode. For use in the electrolysis of an aqueous solution of alkali metal chloride, in particular of sodium chloride, a sufficient electrochemical activity is one wherein the cell voltage is not more than 2.5 V at a current density of 4 kA/m².

The pretreatment, according to the invention, of the roll surfaces with the liquid organic compound is sufficient in particular when exclusively powder mixtures of the same composition are rolled in succession under substantially identical conditions. In particular, however, it has been found that a change of the roll surface occurs, for example, as a result of rolling different powder mixtures, for example powder mixtures having different compositions with regard to their components and/or their weight ratios, in succession on the same roll mill. Owing to the changed roll surface, sheet-like structures which have the same composition and are produced with the same roll parameters, in particular no longer have the same thickness and density, and hence the same electrochemical activity. Thus, for example, a sheet-like structure which was produced from a powder mixture consisting of 90% by weight of silver(I) oxide and 10% by weight of PTFE cannot be produced again with the same thickness and density if, before the rolling, a mixture consisting of 80% by weight of silver(I) oxide and 20% by weight of PTFE is first rolled. The treatment, according to the invention, of the roll surface only with one of the organic solvents or a mixture of the organic solvents no longer achieved the desired properties in the case of the sheet-like structures. Furthermore, the treatment of the roll surfaces with conventional cleaning agents, as known from the household, for example abrasives, such as Sidol® or Frosch®, did not result in improved properties of the sheet-like structures. The surface characteristics could be restored, for example, by removing the roll shells and turning or grinding their surface. However, the removal of the roll shells from the roll mill and mechanical turning or grinding of the roll surfaces inevitably leads to long down times and to tolerances which result from the turning process or grinding process and which adversely affect the truth of running of the rolls.

The method according to the invention is distinguished by its simplicity and the fact that it employs few additional materials and additional operations.

Preferred organic liquid compounds are furthermore those whose boiling point are in the range of 30 to 150° C., particularly preferably in the range of 40 to 100° C. This ensures rapid drying by evaporation, which is advantageous particularly when surfaces are treated with the solvent during the rolling process without the rolling process being interrupted.

During the rolling of the polytetrafluoroethylene powder, the circumferential velocity of the rolls, independently of one another, is preferably 0.3 to 6 m/min.

Furthermore, the rolling of the polytetrafluoroethylene powder by the method according to the invention is preferably effected under a clamping force of 0.05 to 15 kN/cm.

The temperature of the polytetrafluoroethylene powder during the rolling is preferably 10 to 70° C.

The milling of the polytetrafluoroethylene powder by the method according to the invention is preferably effected in a mill having high-speed blades, as described, for example, in DE 2 941 774, the circumferential velocity of the rotating blade being at least 15 m/s, preferably at least 25 m/s, particularly preferably 40 m/s. The milling gives a PTFE of fibrous structure, and it is for this reason that those polyfluoroethylene powders which tend to fibrillation are preferably used. These include, for example, PTFE of the type TF 2021, TF 2053 or TF 2029 from DYNEON.

The rolling of the powder mixture can be effected using conventional roll shells, as used in the production of sheet-like structures of this type or in the compacting of powders. Individual rolls may have different diameters which are preferably not more than 15 cm and may run at different velocities, in particular at circumferential velocities in the range of 0.05 to 19 m/min. The roll surfaces should have a roughness which enables the powder mixture to be drawn in at a speed which is still uniform. The aim is to produce a homogeneous sheet-like structure. The surface roughness of the roll can be adapted according to the property of the powder mixture. Smooth roll surfaces are preferably employed, i.e. surfaces which do not have a coarse structure. The surface roughness of the roll, measured as the Ra number, is preferably between 0.05 μm and 1.5 μm.

The rolling of the dry powder mixtures is effected by a procedure in which the dry powder mixture is metered onto the roll nip, and the roll shells draw in the powder and compact it to give a sheet-like structure. The sheet-like structure produced has a thickness of 0.05 to 0.8 mm, preferably of 0.15 to 0.7 mm.

For the use of the sheet-like structure as gas diffusion electrode in an electrolysis process, the sheet-like structure is joined to an electrically conductive support. The electroconductive support is, for example, a metal net, a metal nonwoven or a woven metal fabric. Furthermore, it may be a carbon net, a carbon nonwoven or a woven carbon fabric or a corresponding net, etc. of other electrically conductive materials. The sheet-like structure is preferably joined by rolling into the support, i.e. the net or the like.

### EXAMPLE 1

A powder mixture consisting of silver(I) oxide and polytetrafluoroethylene (PTFE), having a composition of 90% by weight of silver(I) oxide and 10% by weight of PTFE, was milled by means of a high-speed beater mill from IKA, type M20, at intervals of, in each case, 15 seconds with cooling and then rolled on a roll mill from Wetzel, comprising two roll shells having a width of 40 cm and a diameter of 13 cm, under a clamping force of 2.2 kN/cm. Before the rolling, the roll surfaces were rubbed with ethanol, to which 0.2% by volume of methyl isobutyl ketone had been added, using a cloth, and the roll surfaces were then dried in the air at room temperature. After the drying, the powder mixture was fed to the roll nip. During the rolling, the circumferential velocity of the rolls was 1.35 m/min. The sheet-like structure did not remain adhering to the roll surface and had a thickness of 0.35 mm at a density of 4.65 g/ml.

### EXAMPLE 2

After the rolling process described in example 1, with pretreatment of the roll surface, a powder mixture of 80% by weight of silver(I) oxide and 20% by weight of PTFE, which had been milled analogously to example 1, was rolled on the same roll mill under the conditions described in example 1. When a milled mixture consisting of 90% by weight of silver(I) oxide and 10% by weight of PTFE was furthermore rolled, the thickness of the sheet-like structure was 0.5 mm at a density of 4.7 g/ml, i.e. the sheet-like structure had a greater thickness and a higher density than those found in example 1.

The properties of the sheet-like structure which are described under example I could be achieved again only after milled PTFE powder from DYNEON, type TF 2053, had been rolled on the roll mill to give a sheet-like structure. The rotational speed of the rolls was adjusted so that the circumferential velocity was 1.35 m/min. The clamping force was 0.8 kN/cm. The temperature of the PTFE powder was 22° C.

The PTFE powder had been milled beforehand in each case at 150 ml fractions for 60 s in a laboratory mill from IKA, type M20, having beater blades, and had been cooled to room temperature.

1. A method for producing sheet-like structures for gas diffusion electrodes, in which the sheet-like structure is produced by a pair of rolls by rolling a dry powder mixture, containing at least one catalyst or a catalyst mixture and a binder, wherein a liquid organic compound, comprising: an alcohol of the formula 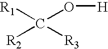
in which R₁, R₂ and R₃ are identical or different and are hydrogen or aliphatic or cycloaliphatic alkyl radicals, R₁, R₂ and R₃ together comprising not more than 8 C atoms, or are aryl radicals having 6 C atoms, not more than one of the radicals R₁, R₂ or R₃ being those aryl radicals in which optionally one or more hydrogen atoms are replaced by an alkyl radical having not more than 8 C atoms, or a mixture of such alcohols, and/or a ketone of the formula 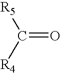
in which R₄ and R₅ are identical or different and are aliphatic or cycloaliphatic alkyl radicals, R₄ and R₅ together comprising not more than 8 C atoms, or are aryl radicals having 6 C atoms, not more than one of the radicals R₄ or R₅ being an aryl radical in which optionally one or more hydrogen atoms are replaced by an alkyl radical having not more than 8 C atoms, or a mixture of such ketones, and/or an ester of the general formula 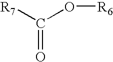
in which R₆ and R₇ are identical or different and are aliphatic or cycloaliphatic alkyl radicals, R₆ and R₇ together comprising not more than 8 C atoms, or R₇ is an aryl radical having 6 C atoms in which optionally one or more hydrogen atoms are replaced by an alkyl radical having not more than 8 C atoms, or a mixture of such esters,
is applied to the roll surfaces of the pair of rolls, so that the total surface area is covered, before being brought into contact with the powder mixture, and the roll surfaces are then dried.

2. A method for producing sheet-like structures for gas diffusion electrodes, in which the sheet-like structure is produced by a pair of rolls by rolling a dry powder mixture containing at least one catalyst or a catalyst mixture and a binder, wherein milled powder comprising polytetrafluoroethylene is optionally rolled to give a sheet-like structure, and in addition, one or more roll surfaces of said rolls are treated with a liquid organic compound, before rolling the dry powder mixture.

3. The method as claimed in claim 2, wherein, first the milled powder comprising polytetrafluoroethylene is rolled to give a sheet-like structure, the liquid organic compound is then applied to roll surfaces and the roll surfaces are dried, and then the dry powder mixture is rolled to give a sheet-like structure for gas diffusion electrodes.

4. The method as claimed in claim 1, wherein the liquid organic compound is ethanol, isobutyl ketone or acetone.

5. The method as claimed in claim 1, wherein the liquid organic compound has a boiling point in the range of 30° to 150°.

6. The method as claimed in claim 5, wherein the liquid organic compound has a boiling point in the range of 40° to 100° C.

7. The method as claimed in claim 2, wherein during the rolling of the polytetrafluoroethylene powder, the circumferential velocity of the rolls, independently of one another, are 0.3 to 6 m/min.

8. The method as claimed in claim 2, wherein the rolling of the polytetrafluoroethylene powder is effected under a clamping force of 0.05 to 15 kN/cm.

9. The method as claimed in claim 2, wherein the temperature of the powder comprising polytetrafluoroethylene during the rolling of the polytetrafluoroethylene powder is 10 to 70° C.

10. The method as claimed in claim 2, wherein the powder comprising polytetrafluoroethylene is milled using a mill having high-speed blades, the circumferential velocity of the rotating blades being at least 15 m/s.

11. The method of claim 10, wherein said velocity is at least 25m/s.

12. The method of claim 1, wherein said powder comprises polytetrafluoroethlene.

13. The method as claimed in claim 12, wherein, first the milled powder comprising polytetrafluoroethylene is rolled to give a sheet-like structure, the liquid organic compound is then applied to roll surfaces and the roll surfaces are dried, and then the dry powder mixture is rolled to give a sheet-like structure for gas diffusion electrodes.

14. The method as claimed in claim 12, wherein during the rolling of the polytetrafluoroethylene powder, the circumferential velocity of the rolls, independently of one another, are 0.3 to 6 m/min.

15. The method as claimed in claim 12, wherein the rolling of the polytetrafluoroethylene powder is effected under a clamping force of 0.05 to 15 kN/cm.

16. The method as claimed in claim 12, wherein the temperature of the powder comprising polytetrafluoroethylene during the rolling of the polytetrafluoroethylene powder is 10 to 70° C.

17. The method as claimed in claim 12, wherein the powder comprising polytetrafluoroethylene is milled using a mill having high-speed blades, the circumferential velocity of the rotating blades being at least 15 m/s.

18. The method of claim 17, wherein said velocity is at least 25m/s.

19. The method as claimed in claim 2, wherein the liquid organic compound is ethanol, isobutyl ketone or acetone.

20. The method as claimed in claim 2, wherein the liquid organic compound has a boiling point in the range of 30° to 150°.
